(19) United States
(12) Patent Application Publication
(10) Pub. No.: US 2025/0310571 A1
(43) Pub. Date: Oct. 2, 2025

(54) VIDEO FILE SENDING METHOD, VIDEO FILE RECEIVING METHOD, AND TERMINAL

(71) Applicants: SHANGHAI JIAO TONG UNIVERSITY, Shanghai (CN); GUANGDONG OPPO MOBILE TELECOMMUNICATIONS CORP., LTD., Dongguan (CN)

(72) Inventors: Yiling XU, Dongguan (CN); Zhiyao YANG, Dongguan (CN); Xueji JIN, Dongguan (CN); Jun DENG, Dongguan (CN); Yifan WANG, Dongguan (CN)

(21) Appl. No.: 19/237,533

(22) Filed: Jun. 13, 2025

Related U.S. Application Data
(63) Continuation of application No. PCT/CN2023/123949, filed on Oct. 11, 2023.

(30) Foreign Application Priority Data
Dec. 13, 2022 (CN) 202211603003.5

(51) Int. Cl. H04N 19/70; H04N 19/136

(52) U.S. Cl. CPC H04N 19/70; H04N 19/136

(57) ABSTRACT

Provided are a video file sending method, a video file receiving method, and a terminal. In the method, at least two videos captured under at least two view angles are determined. A first video file is generated based on the at least two videos and multi-view file description information, and the first video file is written into a bitstream. The multi-view file description information is used to instruct a terminal to decode the first video file in a multi-view manner.

### CROSS-REFERENCE OF RELATED APPLICATION

This application is a continuation of International Application No. PCT/CN2023/123949 filed Oct. 11, 2023, which claims priority to Chinese Patent Application No. 202211603003.5 filed Dec. 13, 2022, and the entire contents of them are incorporated herein by reference.

### TECHNICAL FIELD

The present disclosure relates to the field of video encoding and decoding, and particularly to a video file sending method, a video file receiving method, and a terminal.

### BACKGROUND

With the rapid development of media technology, users have higher and higher demands for the experience of media consumption. The media business experience based on network capabilities presents a development trend of diversified consumption and user personalization. Visual communication technologies represented by multi-view video, virtual reality, augmented reality, mixed reality, etc. may generate, through an auxiliary device, a human-computer interaction environment combining reality and virtuality, and provide the users “immersive” experience with a high degree of realism, deeper immersion, and stronger interactivity, meeting the demands of immersion, personalization, multi-terminal, and strong interaction in the Internet era. Particularly, multi-view videos, which further combine immersion and strong interactivity, have gradually become a new trend in future media services. During the process of experiencing at a terminal, the user can freely choose one or more view angles to view details of multiple view angles, which is not restricted by angles, camera positions, etc., thereby achieving a better viewing effect.

However, at present, when content of videos captured under multiple view angles are organized and transmitted, there is information redundancy in data interaction between the server and the client, which reduces the transmission efficiency of a multi-view video file.

### SUMMARY

The present disclosure provides a video file sending method, a video file receiving method, and a terminal.

The technical solutions of the present disclosure are implemented as follows.

The embodiments of the present disclosure provide a video file sending method, and the method includes:
determining at least two videos captured under at least two view angles; and
generating a first video file, based on the at least two videos and multi-view file description information, and writing the first video file into a bitstream, where the multi-view file description information is used to instruct a terminal to decode the first video file in a multi-view manner.

The embodiments of the present disclosure provide a video file receiving method, and the method includes:
determining a first video file by parsing a bitstream;
determining multi-view file description information by parsing the first video file, where the multi-view file description information is used to instruct a terminal to decode the first video file in a multi-view manner; and
decoding the first video file according to the multi-view file description information, and obtaining, through the decoding, at least two videos captured under at least two view angles.

The embodiments of the present disclosure provide a terminal, and the terminal includes:
a memory configured to store executable data instructions; and
a processor configured to execute the executable data instructions stored in the memory to implement the video file receiving method mentioned above.

### BRIEF DESCRIPTION OF THE DRAWINGS

FIG. 1 illustrates an existing method for generating a multi-view video file.

FIG. 2 illustrates an existing transmission method for the multi-view video file.

FIG. 3 illustrates another existing transmission method for video files at multiple view angles.

FIG. 4 is an alternative flow chart of a video file sending method provided in the embodiments of the present disclosure.

FIG. 5 is an alternative flow chart of a video file receiving method provided in the embodiments of the present disclosure.

FIG. 6 is an alternative interaction flow chart of the video file sending method and the video file receiving method provided in the embodiments of the present disclosure when being applied to an actual scene.

FIG. 7 is a schematic diagram illustrating data interaction of the video file sending method and the video file receiving method provided in the embodiments of the present disclosure when being applied to an actual scene.

FIG. 8 illustrates an alternative schematic structural diagram of a video file sending apparatus provided in the embodiments of the present disclosure.

FIG. 9 illustrates an alternative schematic structural diagram of a video file receiving apparatus provided in the embodiments of the present disclosure.

FIG. 10 illustrates an alternative schematic structural diagram of a server provided in the embodiments of the present disclosure.

FIG. 11 illustrates an alternative schematic structural diagram of a terminal provided in the embodiments of the present disclosure.

### DETAILED DESCRIPTION OF PREFERRED EMBODIMENTS

In order to make the purpose, technical solutions and advantages of the present disclosure more clearly, the present disclosure will be further described in detail below in conjunction with the drawings. The described embodiments should not be regarded as limiting the present disclosure. All other embodiments obtained by those skilled in the art without paying creative work fall within the scope of protection of the present disclosure.

In the following description, the mentioned expression “some embodiments” describe a subset of all possible embodiments, but it is understandable that “some embodiments” may represent a same subset or different subsets of all possible embodiments and may be combined with each other without conflict.

In the following description, terms “first\second\third” involved are merely used to distinguish similar objects and do not represent a specific order of the objects. It is understandable that “first\second\third” may be interchanged for a specific order or sequence where permitted, so that the embodiments of the present disclosure described herein can be implemented in an order other than that illustrated or described here.

Unless defined otherwise, all technical and scientific terms used herein have the same meaning as commonly understandable by those skilled in the art to which the present disclosure belongs. The terms used herein are only for the purpose of describing the embodiments of the present disclosure and are not intended to limit the present disclosure.

At present, there are generally two approaches to organize and transmit video media content files obtained under multiple view angles. The two approaches are illustrated as follows.

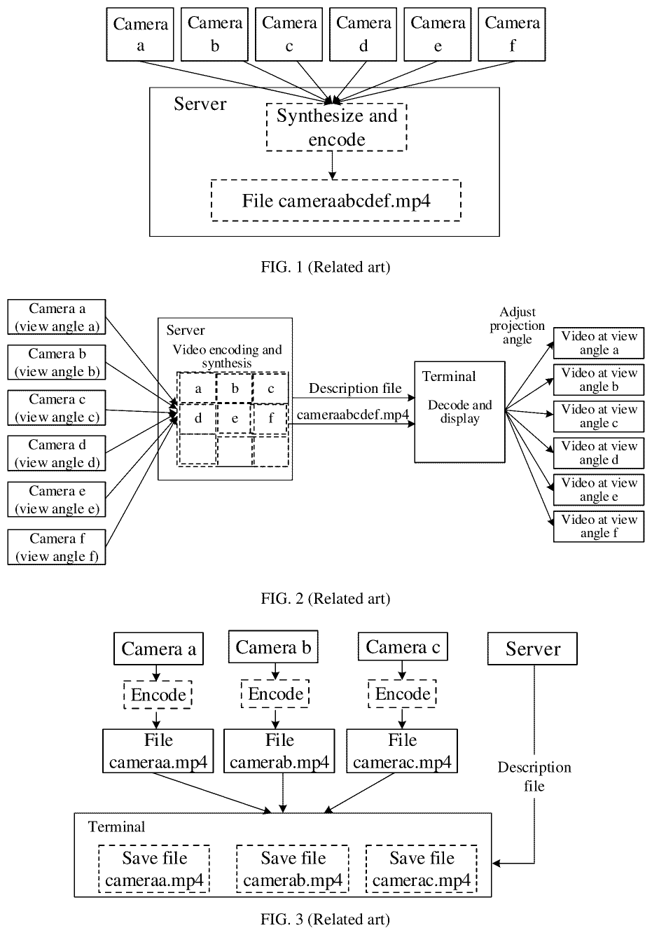

Approach 1: as illustrated in FIG. 1, image acquisition devices, such as camera a, camera b, camera c . . . , and camera f, respectively capture videos from different view angles, and transmit the videos to the server. The server encodes and synthesizes the videos captured by the cameras from multiple view angles, to obtain a multi-view video file, such as the file cameraabcdef.mp4 as illustrated in FIG. 1. Then, as illustrated in FIG. 2, the server transmits the synthesized file cameraabcdef.mp4 to a terminal (client), and additionally transmits a description file to the terminal, where the description file indicates that cameraabcdef.mp4 is a multi-view video file and indicates an association relationship among the videos captured under the multiple view angles. As such, the terminal may decode the multi-view video file to obtain the videos captured under the multiple view angles, and present the multiple videos captured under the multiple view angles for the user to choose. Then, based on the view angle selected by user, the terminal may project the video content captured at the selected view angle. That is, when the user selects a different view angle, the video content captured by the camera corresponding to the selected view angle is played to implement multi-view presentation.

Approach 2: as illustrated in FIG. 3, camera a, camera b and camera c capture videos from different view angles respectively, and each of them encodes its captured video so that video files at different view angles, such as cameraa.mp4, camerab.mp4 and camerac.mp4, are generated. The video files at different view angles are stored in corresponding locations. The server sends a description file to the terminal, where the description file includes information indicating that camraa.mp4, camerab.mp4 and camerac.mp4 are videos that are captured at multiple view angles and associated with a same scene, and includes information indicating respective storage locations of camraa.mp4, camerab.mp4 and camerac.mp4. The terminal downloads and decodes each of camraa.mp4, camerab.mp4 and camerac.mp4 according to the description file sent by the server, and then presents content of the videos at multiple view angles, so that the user can change the view angle desired to watch.

As can be seen, for the existing two transmission approaches for a multi-view file, the server needs to send an additional description file to inform the client of whether the sent video file is of a multi-view file type and indicate the association relationship between the files at multiple view angles. Otherwise, the client would present the videos as an ordinary file. This causes redundancy in information transmission and reduces the transmission efficiency of the multi-view video file. Furthermore, in approach 2, when multiple video files are stored and forwarded, for example, when multiple video files are stored in a mobile storage device or shared and propagated via a network, the multiple video files need to be copied multiple times, which reduces the storage and sharing efficiency.

The embodiments of the present disclosure provide a video file sending method and apparatus, a video file receiving method and apparatus, and a computer-readable storage medium, by which the transmission efficiency of a multi-view video file can be improved. Exemplary applications according to the embodiments of the present disclosure where the video file sending method is applied to a server and the video file receiving method is applied to a terminal will be described respectively below. In some embodiments, the terminal may be implemented as various types of user terminals, such as a laptop computer, a tablet computer, a desktop computer, a set-top box, a mobile device (e.g., a smart phone, and a smart watch). In some embodiments, the server may be an independent physical server, a server cluster or distributed system composed of multiple physical servers, or a cloud server which provides basic cloud computing services, such as cloud services, cloud databases, cloud computing, cloud functions, cloud storage, network services, cloud communications, middleware services, domain name services, security services, CDN, as well as big data and artificial intelligence platforms. The terminal and the server may be connected directly or indirectly via wired or wireless communication, which is not limited in the embodiments of the present disclosure.

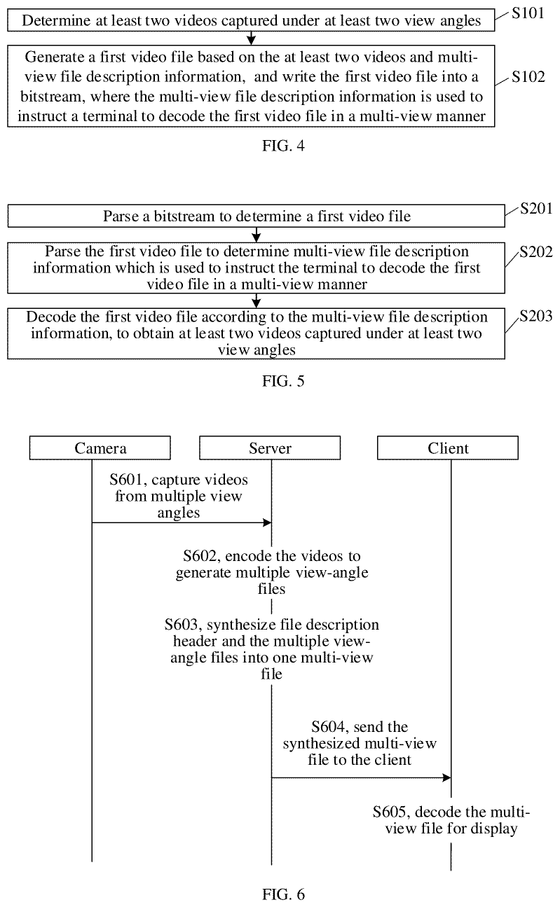

As illustrated in FIG. 4, an alternative flow chart of a video file sending method provided in the embodiments of the present disclosure when being applied to a server is shown. It is explained in conjunction with operations illustrated in FIG. 4.

At S101, at least two videos captured under at least two view angles are determined.

In the embodiments of the present disclosure, by synchronously capturing, through image acquisition devices deployed at different locations, images of a preset scene such as a sports event or a natural environment, the server obtains at least two videos captured under at least two view angles.

In some embodiments, the image acquisition devices may include at least two single-view cameras. Alternatively, the image acquisition device may also include a multi-view camera configured with a multi-view pick-up head, such as a stereo camera, an omnidirectional camera, a virtual reality (VR) camera; through at least two pick-up heads with different view angle ranges deployed on the multi-view camera(s), at least two videos captured under at least two view angles are obtained. The image acquisition devices may be arranged in a preset array in such a manner that the preset scene is covered by the different view angle ranges. The specific selection is made according to the actual situation, which is not limited in the embodiments of the present disclosure.

At S102, a first video file is generated based on the at least two videos and multi-view file description information, and the first video file is written into a bitstream, where the multi-view file description information is used to indicate whether the video file is a multi-view file and indicate the number of videos in the video file.

In the embodiments of the present disclosure, the server merges/combines the at least two videos with the multi-view file description information to generate the first video file. The server performs bit encoding on the first video file, writes the encoded first video file into a bitstream, and sends the bitstream to a terminal. The multi-view file description information is used to instruct the terminal to decode the first video file in a multi-view manner. That is, the server may send the at least two videos and the multi-view file description information to the terminal through one data transmission, and may inform the terminal that the first video file is a multi-view video file which includes videos captured under at least two view angles and which needs to be decoded in a multi-view manner for further multi-view presentation.

In some embodiments, the server may take/configure the multi-view file description information as header information such as a file header of the first video file, and combine it with the at least two videos to generate the first video file.

Alternatively, the server may also configure the multi-view file description information as information of another preset field, for example, it configures the multi-view file description information as tail information; then, the server may combine the multi-view file description information with the at least two videos to generate the first video file. The specific selection is made according to the actual situation, which is not limited in the embodiments of the present disclosure.

In some embodiments, the at least two videos may be videos after undergoing video encoding, and the server may directly combine the at least two encoded videos with the multi-view file description information to generate the first video file.

In some embodiments, before S102, the server may also first perform video encoding on the at least two unencoded original videos captured under the at least two view angles to obtain at least two encoded videos, and then combine the at least two encoded videos with the multi-view file description information to generate the first video file.

In some embodiments, the multi-view file description information may include view-angle indication information and a video quantity. The view-angle indication information is used to indicate whether the first video file is a multi-view file. The video quantity represents the number of videos included in the first video file. In this way, by means of the view-angle indication information in the multi-view file description information, the server may inform the terminal of whether the terminal needs to perform the decoding in a multi-view manner; and by means of the video quantity, the server may inform the terminal of the number of videos that need to be decoded. As such, the terminal may decode the first video file in a multi-view manner according to the number of videos.

In some embodiments, the multi-view file description information may also include information on decoding according to actual demands. For example, the multi-view file description information may include a data range occupied by each video in the first video file, to assist the terminal in decoding the at least two videos more quickly; and/or, the multi-view file description information may include layout information used for multi-view presentation on the terminal, such as a video arrangement mode and a video arrangement order for displaying the at least two videos captured under the at least two view angles. The specific selection is made according to the actual situation, which is not limited in the embodiments of the present disclosure.

It is understandable that, in the embodiments of the present disclosure, after the at least two videos captured under the at least two view angles are determined, the first multi-view video file is synthesized based on the at least two videos and the multi-view file description information. As such, the multi-view file description information and the videos captured under multiple view angles are combined into a complete functional file for transmission. In this way, not only can the terminal be effectively informed of decoding the first video file in a multi-view manner, but the number of transmissions can also be reduced, thereby improving the transmission efficiency of a multi-view video file.

In some embodiments, the multi-view file description information may also include at least one of video arrangement information and video association information.

The video arrangement information represents a splicing layout at which the at least two videos are spliced in the first video file. In some embodiments, when the server synthesizes the at least two videos into the first multi-view video file, for at least two video images at a same frame time in the at least two videos, the server may splice the at least two video images into a large multi-view video image according to the video arrangement information, and then perform encoding and compression thereon to obtain a bitstream.

In some embodiments, the video arrangement information includes the number of rows arranged and the number of columns arranged. In some embodiments, the video arrangement information may further includes a row number and a column number of each video in the arranged rows and columns. According to the number of rows arranged and the number of columns arranged, the server may perform image splicing on the at least two video images at the same frame time in the at least two videos, to obtain a multi-view video image at the frame time. The server obtains multi-view video images at individual frame times by performing similar splicing, and a multi-view spliced video is thereby obtained. The server combines the multi-view spliced video with the multi-view file description information to obtain the first video file. The specific numbers of arranged rows and columns may be pre-set according to actual demands, which is not limited to the embodiments of the present disclosure.

It is understandable that, through the video arrangement information in the multi-view file description information, it is possible to instruct the terminal to organize, according to the preset numbers of rows and columns specified by the server, the decoded videos under individual view angles in a corresponding file format, which improves the uniformity and standardization for transmission and storage of the multi-view video file.

In the embodiments of the present disclosure, the video association information in the multi-view file description information represents a data association relationship between the at least two videos in the first video file, and/or video attribute information. In some embodiments, the video association information may include: video lengths and offset starting points of the at least two videos in the first video file; and/or video attribute information. That is, the video association information may include the video lengths and the offset starting points of the at least two videos in the first video file; or video attribute information; or the video lengths, the offset starting points of the at least two videos in the first video file, and the video attribute information.

The video lengths include a data length of each video in the at least two videos, and the offset starting points include a data position in the first video file where the starting data (such as the first byte) of each video is located. In this way, based on the video lengths and the offset starting points, the data range occupied by each video in the first video file may be determined, and the relationship structure of the at least two videos in the first video file may thus be determined.

In some embodiments, the video association information may further include: an offset starting point and an offset end point of each video; and/or video attribute information. Alternatively, the video association information may also include: the video lengths and a combination order of the at least two videos in the first video file; and/or video attribute information. The specific selection is made according to the actual situation, which is not limited in the embodiments of the present disclosure.

In some embodiments, the video attribute information describes the attribute of each video. In some embodiments, the video attribute information at least includes at least one of a capture location, a capture time and captured content of each video. In some embodiments, the video attribute information may also include tag information, author information, video parameter information (such as resolution and frame rate), video classification information (such as architecture, scenery or sports), information on the image acquisition device, etc. The specific selection is made according to the actual situation, which is not limited in the embodiments of the present disclosure.

It is notable that the video attribute information represents the attributes of the individual videos. In some embodiments, the multi-view file description information may further include file attribute information of the synthesized first video file, such as a file size, file name, and other file attribute information of the first video file. The specific selection is made according to the actual situation, which is not limited in the embodiments of the present disclosure.

It is understandable that, based on the video association information in the multi-view file description information, the terminal is informed of the relationship structure of the at least two videos in the first video file, which enables the terminal to use the video association information to efficiently decode the video file, thereby improving the decoding efficiency. In addition, the server informs the terminal of the video attribute information of each video in the multi-view file description information. The terminal may thus store the video attribute information of each video and the video in a corresponding relation, and may perform further image processing on the videos according to the video attribute information thereof, thereby improving the uniformity, standardization and richness in processing the multi-view video.

In some embodiments, the information structure (i.e., data structure) of the multi-view file description information may include a preset first structure. The preset first structure includes a view-angle indication information field and a video quantity field. The view-angle indication information field is a field for the view-angle indication information. The video quantity field is a field for the video quantity. The server may write the view-angle indication information in the view-angle indication information field of the preset first structure and write the video quantity in the video quantity field of the preset first structure, to obtain the multi-view file description information including the view-angle indication information and the video quantity.

In some embodiments, the preset first structure may further include a video arrangement information field. The video arrangement information field is a field for the video arrangement information.

In some embodiments, the preset first structure further includes a preset second structure. The preset second structure includes: a video length field and a video offset starting point field; and/or a video attribute information field.

The video length field is a field for the video lengths. The video offset starting point field is a field for the offset starting points of the at least two videos in the first video file. The video attribute information field is a field for the video attribute information.

As can be seen, the preset first structure includes information fields for the first video file, the preset second structure includes information fields for the videos, and the preset second structure is included in the preset first structure. In some embodiments, the preset first structure and the preset second structure may be in a nested relationship, that is, the preset second structure is a member of the preset first structure.

Exemplarily, the above video arrangement information field may include a row number field and a column number field. The row number field is a field for the number of rows arranged in the video arrangement information. The column number field is a field for the number of columns arranged in the video arrangement information. The preset first structure may be as follows:

```
  struct relm{
  length: 8byte//Data length of the preset first structure (relm structure), 8 bytes;
  sourcenum: 4byte//Video quantity field, 4 bytes;
  row: 4byte//Row number field, representing the number of rows arranged, 4 bytes;
  col: 4byte//Column number field, representing the number of columns arranged, 4
bytes;
  mvde[4]}//The preset second structure, including 4 fields.
```

Exemplarily, the video association information may further include a video view-angle field, and the above preset second structure mvde includes:

```
  Struct mvde{
  angle: 4byte//Video view-angle field, representing view angles of the videos, 4 bytes;
  offsetstart: 8byte//Video offset starting point field, representing the offset starting
points of the videos in the first video file, 8 bytes;
  filesize: 8byte//Video length field, representing the video lengths of the videos, that
is, the data length of the video file, 8 bytes;
  desc//Video attribute information field}
```

In some embodiments, the information structure of the multi-view file description information may also be expanded according to actual information transmission demands. Exemplarily, the preset first structure may further include a multi-view file attribute information field for the file attribute information of the first video file, and the preset second structure may further include fields related to other attributes of the videos, etc. The specific selection is made according to actual conditions, which is not limited in the embodiments of the present disclosure.

It is understandable that, by taking the preset structures as the information structure of the multi-view file description information, the transmission manner of the multi-view file is further standardized, and the uniformity and standardization for transmission of the multi-view file are improved.

As illustrated in FIG. 5, an alternative flow chart of the video file sending method provided in the embodiments of the present disclosure when being applied to a terminal is shown. It is explained in conjunction with operations illustrated in FIG. 5.

At S201, a bitstream is parsed, and a first video file is determined.

At S202, the first video file is parsed to determine multi-view file description information, where the multi-view file description information is used to instruct the terminal to decode the first video file in a multi-view manner.

In the embodiments of the present disclosure, the terminal obtains the first video file by parsing the bitstream sent from the server. The terminal further performs file data parsing on the first video file to obtain the multi-view file description information of the first video file.

In some embodiments, the terminal may read and parse the header information of the first video file. Exemplarily, the terminal may read the file header of the first video file and perform data parsing thereon to determine the multi-view file description information.

At S203, the first video file is decoded according to the multi-view file description information, to obtain at least two videos captured under at least two view angles.

In the embodiments of the present disclosure, the terminal decodes the first video file in a multi-view manner according to the multi-view file description information, thereby obtaining at least two videos captured under at least two view angles.

In some embodiments, the multi-view file description information includes view-angle indication information and video quantity. The view-angle indication information is used to indicate whether the first video file is a multi-view file. The video quantity represents the number of videos included in the first video file. When the view-angle indication information indicates that the first video file is a multi-view file, the terminal may decode the first video file according to the video quantity, that is, the terminal decodes the first video file in a multi-view manner, thereby obtaining the at least two videos.

Here, when the view-angle indication information indicates that the first video file is a multi-view file, the terminal may know therefrom that the first video file includes at least two videos; in addition, the terminal may know the number of videos needed to be decoded, based on the video quantity. Therefore, the terminal decodes the first video file according to the above information, to obtain the at least two videos captured under at least two view angles.

It is understandable that, in the embodiments of the present disclosure, the terminal receives a complete first video file at a time, obtains the multi-view file description information parsed from the first video file, and obtains at least two videos captured under at least two view angles by decoding the first video file according to the multi-view file description information, thereby completing the decoding of the multi-view video file. In this way, the number of transmissions is reduced, and the transmission efficiency of the multi-view video file is improved.

In some embodiments, when the multi-view file description information includes video association information, the terminal may also determine, according to the video association information, to-be-decoded data of each video in the at least two videos, and decode the to-be-decoded data of each video, thereby obtaining the at least two videos.

Exemplarily, when the video association information includes video lengths and offset starting points of the at least two videos in the first video file, the terminal may determine the to-be-decoded data according to the offset starting points and the video lengths. That is, the terminal may determine, according to the video association information, the data range occupied by each video from the first video file synthesized by the server, and thus determine the to-be-decoded data of each video.

It is understandable that, when the terminal decodes the multi-view video file, the terminal may split and decode, according to the video association information in the multi-view file description information informed by the server, the data of each view angle in the multi-view video file, thereby improving the decoding efficiency.

In some embodiments, when the video association information includes video attribute information, the terminal may store the video attribute information and the decoded videos in a corresponding relation, so that the user may know the attribute information of a video while sharing or reading this video. The terminal may also further process the stored videos captured under multiple view angles according to the video attribute information, for example, it may sort the videos according to size or name, or classify the videos according to tag information or information on image acquisition device. The specific selection is made according to the actual situation, which is not limited in the embodiments of the present disclosure.

It is understandable that, the terminal may make unified attribute description of the videos according to the video attribute information, and may obtain more video related information, thereby improving the uniformity, standardization and richness of processing the multi-view video.

In some embodiments, when the multi-view file description information includes video arrangement information, the terminal may further display the decoded at least two videos in a multi-view presentation manner, according to the video arrangement information, which is described as follows.

According to the video arrangement information, the terminal may determine a projection position of each video in the at least two videos, and display the at least two videos based on the respective projection positions.

In the embodiments of the present disclosure, according to the number of rows arranged and the number of columns arranged in the video arrangement information, that is, according to the arrangement layout at which the server performs the multi-view splicing, the terminal may determine the projection positions of the at least two videos captured under at least two view angles for display on the terminal, and then display the at least two videos in a multi-view presentation manner.

In some embodiments, a preset display interface of the terminal may display the at least two videos captured under at least two view angles in a grid-like layout. In this case, according to the row number and column number of each video in the arranged rows and columns, the terminal may determine the projection position of the video on a corresponding grid of the preset display interface, and display the video at the determined projection position. In this way, the at least two videos captured under at least two view angles are synchronously displayed in a matrix form, so that the user may simultaneously view the videos captured under at least two view angles; in addition, the user may further select one video under a certain view angle, so as to watch from an adjusted view angle.

In some embodiments, the terminal may also take the row number and the column number in the arranged rows and columns as position information in a two-dimensional space, and may determine the projection position of each video in a three-dimensional space according to preset correspondences between position information in the two-dimensional space and the three-dimensional space. Then, the terminal may project each video with a corresponding row number and column number into the three-dimensional space for display, thereby realizing the projection and playback of the at least two videos captured under at least two view angles in the three-dimensional space, and presenting a full-range free view angle display effect.

In some embodiments, when at least one of the number of rows arranged and the number of columns arranged is empty, for example, when at least one of the number of rows arranged and the number of columns arranged is an empty value or zero, the terminal may display the at least two videos in the multi-view presentation manner by means of a program list. Here, the program list refers to a way for multi-view presentation, and the projection position of each view angle is determined by the organizer of the program list. The terminal may determine the projection position of each video according to correspondences between preset view angles and projection positions, and then display each video under a view angle at a corresponding projection position, thereby playing the videos in the multi-view presentation manner.

It is notable that the above embodiments describe how the terminal performs the multi-view presentation according to the arrangement layout specified by the server in the video arrangement information. In actual applications, the terminal may also determine the projection positions of the videos under individual view angles by itself. The specific selection is made according to the actual situation, which is not limited in the embodiments of the present disclosure.

In some embodiments, after the terminal obtains the at least two videos through decoding, it would store the at least two videos in a preset storage path. Here, the terminal may also determine the storage path of each video, and generate a configuration file based on the storage path and projection position of each video, where the configuration file include correspondences between the storage paths and projection positions of the individual videos. In this way, when the terminal performs the multi-view presentation, according to the correspondences between storage paths and projection positions in the configuration file, the terminal may obtain videos under different view angles from the storage paths, and display them at corresponding projection positions.

In some embodiments, the configuration file may further include other information of the multi-view description information, such as video attribute information of each video. The specific selection is made according to the actual situation, which is not limited in the embodiments of the present disclosure.

It is understandable that, according to the video arrangement information of the multi-view file description information, the terminal may deploy and display the videos captured under different view angles. The ways of displaying the multi-view video file on different terminals are unified and standardized, and there is no need to set the display layout for each terminal, thereby improving the uniformity and efficiency of playing the multi-view video.

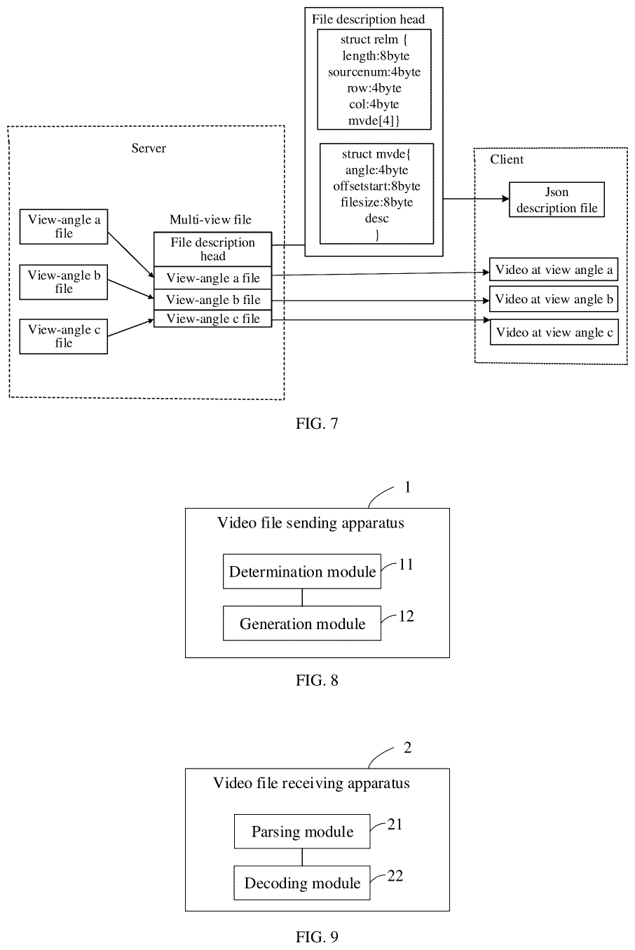

Next, an exemplary application of the embodiments of the present disclosure in a practical application scenario is described in conjunction with FIG. 6 and FIG. 7. The embodiments of the present disclosure may be widely used in practical application scenarios such as multi-view short videos, multi-view live broadcasts of sports events, multi-view live broadcasts of item introductions, and multi-view teaching.

At S601, multiple videos are captured by a camera(s) from different view angles.

Here, at least one camera captures multiple videos from different view angles, such as multiple media contents, and transmits them to the server.

At S602, the server encodes the multiple videos to generate multiple view-angle files.

Here, the multiple view-angle files may be for example a view-angle a file, a view-angle b file, and a view-angle c file as illustrated in FIG. 7.

At S603, the server synthesizes the file description header and the multiple view-angle files into one multi-view file.

Here, the file description header is the multi-view file description information, the multiple view-angle files are the at least two videos, and the multi-view file is the first video file. The information structure of the file description header may be that as illustrated in FIG. 7. The process of S603 is consistent with the process of S102 above, which will not be repeated here.

At S604, the server sends the synthesized multi-view file to a client.

At S605, the client decodes the multi-view file for display.

In S605, the client parses the file description header from the multi-view file, and decodes each view-angle file according to the description information in the file description header, to obtain the videos captured under individual view angles, as illustrated by the video at view angle a, the video at view angle b and the video at view angle c shown in FIG. 7. Furthermore, the terminal/client generates a configuration file according to the description information in the file description header, such as the json description file illustrated in FIG. 7. The json description file includes the paths of the multiple view-angle files and their corresponding projection positions. In this way, the terminal organizes the one multi-view file transmitted by the server into a json description file and a view-angle file list. According to the json file, the terminal may play the decoded multiple view-angle files in the multi-view presentation manner, and the user may change the view angle to watch from an adjusted view angle.

Here, the process of S605 is consistent with the process described in the video file receiving method executed by the terminal, which will not be repeated here.

Exemplarily, when the number of rows arranged (row) and the number of columns arranged (col) in the file description header are not empty, the terminal may perform the multi-view presentation in a grid-like manner. That is, the terminal may determine, according to row and col, the projection position of each video on a corresponding grid, and thus present a projection matrix composed of the videos captured under multiple view angles on the preset display interface. When at least one of the number of rows arranged (row) and the number of columns arranged (col) is empty, the terminal may perform the multi-view presentation in a program list manner. In this case, the terminal may infer the program list content, according to the information content in the json description file and the view-angle file list, that is, the terminal may determine the projection positions of the videos captured under the individual view angles in the program list manner, thereby realizing the multi-view presentation.

It is understandable that, through organization and transmission of the multi-view video file with the methods of the embodiments of the present disclosure, the difficulty of generating the multi-view video content can be reduced, and the way of organizing the multi-view video can be standardized. In addition, not only can the client be effectively informed of whether the video file is a multi-view file, but the secondary transmission can also be avoided. Furthermore, the number of copies by the user can be reduced, the transmission of the multi-view file can be optimized, and it is convenient for a mobile phone product to deploy a multi-view video application. After the client receives information of the multi-view file, it may parse the header file and then process and play the videos captured under multiple view angles. This improves the efficiency of organizing the multi-view file, optimizes the multi-view video technology, and ensures the user's consumption experience.

Based on the aforementioned embodiments, as illustrated in FIG. 8, the embodiments of the present disclosure provide a video file sending apparatus 1, which includes a determination module 11 and a generation module 12.

The determination module 11 is configured to determine at least two videos captured under at least two view angles.

The generation module 12 is configured to generate a first video file based on the at least two videos and multi-view file description information, and write the first video file into a bitstream, where the multi-view file description information is used to instruct a terminal to decode the first video file in a multi-view manner.

In some embodiments of the present disclosure, the generation module 12 is further configured to take the multi-view file description information as header information, and merge the multi-view file description information with the at least two videos to generate the first video file.

In some embodiments of the present disclosure, the multi-view file description information includes view-angle indication information and video quantity. The view-angle indication information indicates whether the first video file is a multi-view file, and the video quantity represents the number of videos included in the first video file.

In some embodiments of the present disclosure, the multi-view file description information further includes at least one of: video arrangement information representing a splicing layout at which the at least two videos are spliced in the first video file; and video association information representing a data association relationship between the at least two videos in the first video file.

In some embodiments of the present disclosure, the video association information includes: video lengths and offset starting points of the videos in the first video file; and/or video attribute information.

The video attribute information at least includes at least one of a capture location, a capture time, and captured content of each video.

In some embodiments of the present disclosure, the video arrangement information includes the number of rows arranged and the number of columns arranged.

In some embodiments of the present disclosure, the video association information further includes video attribute information, and the video attribute information at least includes at least one of a capture location, a capture time, and captured content of each video.

In some embodiments of the present disclosure, an information structure of the multi-view file description information includes a preset first structure.

The preset first structure includes a view-angle indication information field and a video quantity field.

In some embodiments of the present disclosure, the preset first structure further includes a video arrangement information field.

In some embodiments of the present disclosure, the preset first structure further includes a preset second structure.

The preset second structure includes: a video length field and a video offset starting point field; and/or a video attribute information field.

Based on the aforementioned embodiments, as illustrated in FIG. 9, the embodiments of the present disclosure provide a video file receiving apparatus 2, and the apparatus includes a parsing module 21 and a decoding module 22.

The parsing module 21 is configured to parse a bitstream to determine a first video file, and parse the first video file to determine multi-view file description information. The multi-view file description information is used to instruct a terminal to decode the first video file in a multi-view manner.

The decoding module 22 is configured to decode the first video file according to the multi-view file description information, to obtain at least two videos captured under at least two view angles.

In some embodiments, the parsing module 21 is further configured to read and parse header information of the first video file, to determine the multi-view file description information.

In some embodiments, the multi-view file description information includes view-angle indication information and a video quantity. The decoding module 22 is further configured to, when the view-angle indication information indicates that the first video file is a multi-view file, decode the first video file according to the video quantity to obtain the at least two videos.

In some embodiments, the multi-view file description information further includes video association information. The decoding module 22 is further configured to determine, according to the video association information, to-be-decoded data of each video in the at least two videos, and decode the to-be-decoded data of each video, thereby obtaining the at least two videos.

In some embodiments, the video association information includes video lengths and offset starting points of the videos in the first video file. The decoding module 22 is further configured to determine the to-be-decoded data according to the offset starting points and the video lengths.

In some embodiments, the multi-view file description information further includes video arrangement information. The video file receiving apparatus 2 further includes a display module, and the display module is configured to determine a projection position of each video in the at least two videos according to the video arrangement information. The video arrangement information includes the number of rows arranged and the number of columns arranged. The display module is further configured to display the at least two videos according to the projection positions.

In some embodiments, the display module is further configured to, when at least one of the number of rows arranged and the number of columns arranged is empty, determine the projection position of each video according to correspondences between preset view angles and projection positions.

In some embodiments, the video file receiving apparatus 2 further includes a configuration module. The configuration module is configured to, after the projection position of each of the at least two videos is determined, determine a storage path of each video, and generate a configuration file based on the storage path and the projection position of each video. The configuration file includes the correspondence between the storage path and the projection position of each video.

It is notable that the description of the above apparatus embodiments is similar to the description of the above method embodiments, and has similar beneficial effects as the method embodiments. For technical details not disclosed in the apparatus embodiments of the present disclosure, reference may be made to the description of the method embodiments of the present disclosure.

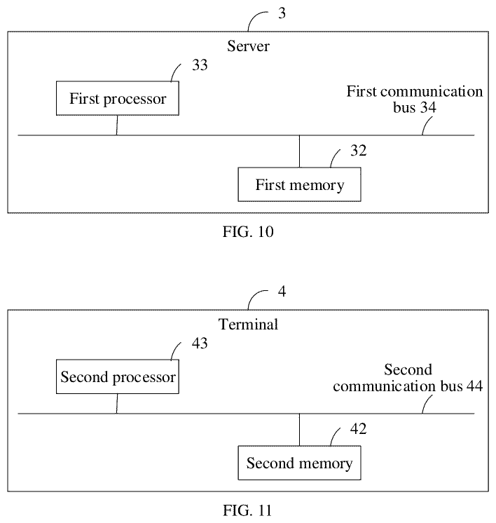

In some embodiments, the embodiments of the present disclosure further provide a server, and FIG. 10 illustrates an alternative schematic structural diagram of a server 3 provided in the embodiments of the present disclosure. As illustrated in FIG. 10, the server 3 includes a first memory 32 and a first processor 33. The first memory 32 and the first processor 33 are connected through a first communication bus 34. The first memory 32 is configured to store executable data instructions. The first processor 33 is configured to execute the executable data instructions stored in the first memory 32 to implement the video file sending method provided in the embodiments of the present disclosure.

In some embodiments, the embodiments of the present disclosure further provide a terminal, and FIG. 11 illustrates an alternative schematic structural diagram of a terminal 4 provided in the embodiments of the present disclosure. As illustrated in FIG. 11, the terminal 4 includes a second memory 42 and a second processor 43. The second memory 42 and the second processor 43 are connected through a second communication bus 44. The second memory 42 is configured to store executable data instructions. The second processor 43 is configured to execute the executable data instructions stored in the second memory 42 to implement the video file receiving method provided in the embodiments of the present disclosure.

The embodiments of the present disclosure provide a bitstream. The bitstream is generated by performing bit encoding on a first video file. The first video file includes at least two videos captured under at least two view angles and multi-view file description information. The multi-view file description information is used to instruct a terminal to decode the first video file in a multi-view manner.

The embodiments of the present disclosure provide a computer program product including a computer program or computer instructions. The computer program or computer instructions, when being executed by a first processor, cause the video file sending method provided in the embodiments of the present disclosure to be implemented; or the computer program or computer instructions, when being executed by a second processor, cause the video file receiving method provided in the embodiments of the present disclosure to be implemented.

The embodiments of the present disclosure provide a non-transitory computer-readable storage medium storing executable data instructions thereon. The executable data instructions, when being executed by the first processor, cause the first processor to implement the video file sending method provided in the embodiments of the present disclosure. Alternatively, the executable data instructions, when being executed by the second processor, cause the second processor to implement the video file receiving method provided in the embodiments of the present disclosure.

In some embodiments, the computer-readable storage medium may be a memory, for example FRAM, ROM, PROM, EPROM, EEPROM, flash memory, magnetic surface memory, optical disk, or CD-ROM; or it may be various devices including one or any combination of the above memories.

In some embodiments, the executable data instructions may be in the form of a program, software, software module, script or code, and written in any form of programming languages (including compiled or interpreted languages, or declarative or procedural languages). In addition, the executable data instructions may be deployed in any form, including being deployed as a stand-alone program or as a module, component, subroutine or other unit suitable for use in a computing environment.

As an example, the executable data instructions may but unnecessarily correspond to a file in a file system. The executable data instructions may be stored as part of a file storing other programs or data. For example, they may be stored in one or more scripts in a Hyper Text Markup Language (HTML) document, in a single file dedicated to the program in question, or in multiple coordinated files (e.g., files storing one or more modules, subroutines, or code portions).

As an example, the executable data instructions may be deployed to be executed on one computing device, or on multiple computing devices located at one site, or on multiple computing devices distributed across multiple sites and interconnected by a communication network.

Those skilled in the art should understand that the embodiments of the present disclosure may be implemented as methods, systems, or computer program products. Therefore, the present disclosure may take the form of a hardware embodiment, a software embodiment, or an embodiment combining software and hardware. Moreover, the present disclosure may take the form of a computer program product implemented on one or more computer-usable storage media (including but not limited to disk storage and optical storage, etc.) containing computer-usable program codes.

The present disclosure is described with reference to flow charts and/or block diagrams of methods, devices (systems), and computer program products according to embodiments of the present disclosure. It should be understand that each process and/or block in the flow chart and/or block diagram, and a combination of the processes and/or blocks in the flow chart and/or block diagram may be implemented by computer program instructions. These computer program instructions may be provided to a processor of a general-purpose computer, a special-purpose computer, an embedded processor or other programmable data processing device to produce a machine, so that the instructions executed by the processor of the computer or other programmable data processing device produce an apparatus for implementing the functions specified in one or more processes in the flow chart and/or one or more blocks in the block diagram.

These computer program instructions may also be stored in a computer-readable memory that can direct a computer or other programmable data processing device to work in a specific manner, so that the instructions stored in the computer-readable memory produce a manufactured product including an instruction apparatus. The instruction apparatus implements the functions specified in one or more processes in the flow chart and/or one or more blocks in the block diagram.

These computer program instructions may also be loaded onto a computer or other programmable data processing device so that a series of operational steps are executed on the computer or other programmable device to produce a computer-implemented process, where the instructions executed on the computer or other programmable device provide steps for implementing the functions specified in one or more processes in the flow chart and/or one or more blocks in the block diagram.

The foregoing is only preferred embodiments of the present disclosure, and is not intended to limit the protection of scope of the present disclosure. Any modifications, equivalent substitutions and improvements made within the spirit and scope of the present disclosure fall within the protection scope of present disclosure.

### INDUSTRIAL APPLICABILITY

In the video file sending method and apparatus, the video file receiving method and apparatus, and the computer-readable storage medium provided in the embodiments of the present disclosure, after the server determines at least two videos captured under at least two view angles, the server synthesizes a first multi-view video file based on the at least two videos and multi-view file description information. As such, the multi-view file description information and the videos captured under multiple view angles are combined into a complete functional file for transmission. In this way, not only can the terminal be effectively informed of decoding the first video file in a multi-view manner, but the number of transmissions can also be reduced, which improves the transmission efficiency of the multi-view video file. The terminal receives a complete first video file at a time, obtains the multi-view file description information parsed from the first video file, and obtains the at least two videos captured under at least two view angles by decoding the first video file according to the multi-view file description information, thereby completing the decoding of the multi-view video file. In this way, the number of transmissions is reduced, and the transmission efficiency of the multi-view video file is improved. Furthermore, by taking the preset structure as the information structure of the multi-view file description information, the transmission manner of the multi-view file is further standardized, and the uniformity and standardization for transmission of the multi-view file are improved.

What is claimed is:

1. A video file sending method, comprising:
determining at least two videos captured under at least two view angles; and
generating a first video file, based on the at least two videos and multi-view file description information, and writing the first video file into a bitstream, wherein the multi-view file description information is used to instruct a terminal to decode the first video file in a multi-view manner.

2. The method as claimed in claim 1, wherein the generating the first video file based on the at least two videos and the multi-view file description information comprises:
generating the first video file, by taking the multi-view file description information as header information and merging the multi-view file description information with the at least two videos.

3. The method as claimed in claim 1, wherein the multi-view file description information comprises view-angle indication information and a video quantity, the view-angle indication information indicates whether the first video file is a multi-view file, and the video quantity represents the number of videos included in the first video file.

4. The method as claimed in claim 3, wherein the multi-view file description information further comprises at least one of:
video arrangement information representing a splicing layout at which the at least two videos are spliced in the first video file; and
video association information representing a data association relationship between the at least two videos in the first video file.

5. The method as claimed in claim 4, wherein the video association information comprises:
video lengths and offset starting points of the at least two videos in the first video file, and/or video attribute information;
the video attribute information at least comprises at least one of a capture location, a capture time, and captured content of each of the at least two videos.

6. The method as claimed in claim 4, wherein the video arrangement information comprises the number of rows arranged and the number of columns arranged.

7. The method as claimed in claim 3, wherein information structure of the multi-view file description information comprises a preset first structure;
the preset first structure comprises a view-angle indication information field and a video quantity field.

8. The method as claimed in claim 7, wherein the preset first structure further comprises a video arrangement information field.

9. The method as claimed in claim 7, wherein the preset first structure further comprises a preset second structure;
the preset second structure comprises: a video length field and a video offset starting point field, and/or a video attribute information field.

10. A video file receiving method, comprising:
determining a first video file by parsing a bitstream;
determining multi-view file description information by parsing the first video file, wherein the multi-view file description information is used to instruct a terminal to decode the first video file in a multi-view manner; and
decoding the first video file according to the multi-view file description information, and obtaining, through the decoding, at least two videos captured under at least two view angles.

11. The method as claimed in claim 10, wherein the determining the multi-view file description information by parsing the first video file comprises:
determining the multi-view file description information by reading and parsing header information of the first video file.

12. The method as claimed in claim 10, wherein the multi-view file description information comprises view-angle indication information and a video quantity;
the decoding the first video file according to the multi-view file description information and obtaining, through the decoding, the at least two videos captured under at least two view angles, comprises:
in response to the view-angle indication information indicating that the first video file is a multi-view file, obtaining the at least two videos by decoding the first video file according to the video quantity.

13. The method as claimed in claim 12, wherein the multi-view file description information further comprises video association information, and the obtaining the at least two videos by decoding the first video file comprises:
determining, according to the video association information, to-be-decoded data of each of the at least two videos; and
obtaining the at least two videos by decoding the to-be-decoded data of each of the at least two videos.

14. The method as claimed in claim 13, wherein the video association information comprises video lengths and offset starting points of the at least two videos in the first video file; and the determining, according to the video association information, the to-be-decoded data of each of the at least two videos, comprises:
determining the to-be-decoded data of each of the at least two videos, according to the offset starting points and the video lengths.

15. The method as claimed in claim 10, wherein the multi-view file description information comprises video arrangement information, and the method further comprises:
determining, according to the video arrangement information, a projection position of each of the at least two videos, wherein the video arrangement information comprises the number of rows arranged and the number of columns arranged, as well as a row number and a column number of each of at least two videos in the arranged rows and columns; and
displaying the at least two videos according to the projection positions of the at least two videos.

16. The method as claimed in claim 15, further comprising:
in response to at least one of the number of rows arranged and the number of columns arranged being empty, determining the projection position of each of the at least two videos according to correspondences between preset view angles and projection positions.

17. The method as claimed in claim 15, wherein after determining the projection positions of the at least two videos, the method further comprises:
determining a storage path of each of the at least two videos; and
generating a configuration file, based on the storage path and the projection position of each of the at least two videos, wherein the configuration file comprises a correspondence between the storage path and the projection position of each of the at least two videos.

18. A terminal, comprising:
a memory, configured to store executable data instructions; and
a processor, configured to execute the executable data instructions stored in the memory to:
determine a first video file by parsing a received bitstream;
determine multi-view file description information by parsing the first video file, wherein the multi-view file description information is used to instruct the terminal to decode the first video file in a multi-view manner; and
decode the first video file according to the multi-view file description information, and obtain, through the decoding, at least two videos captured under at least two view angles.

19. The terminal as claimed in claim 18, wherein the processor is further configured to:
determine the multi-view file description information by reading and parsing header information of the first video file.

20. The terminal as claimed in claim 18, wherein the multi-view file description information comprises view-angle indication information and a video quantity, and the processor is further configured to:
in response to the view-angle indication information indicating that the first video file is a multi-view file, obtain the at least two videos by decoding the first video file according to the video quantity, wherein the video quantity represents the number of videos included in the first video file.
